(19) United States
(12) Patent Application Publication
(10) Pub. No.: US 2004/0022702 A1
(43) Pub. Date: Feb. 5, 2004

(54) Apparatus and method for automatically feeding the silver electrode into the solutiion

(76) Inventor: Herbert E. Christensen, Alpine, UT (US)

Correspondence Address: Herbert E. Christensen, 816 E. Cottonwood Cir., Alpine, UT, 84004, US

(21) Appl. No.: 10/207,632

(22) Filed: Jul. 30, 2002

(51) Int. Cl. B01J 19/08

(52) U.S. Cl. 422/186.21

(57) ABSTRACT

An apparatus and method for positioning each of the many silver electrodes into the tank of water such that arcing does not occur. This consists of a light or electromagnetic detector held in the tank of water so as to be close to the point where the silver electrode comes in contact with the water. When the silver electrode comes close enough to the water that an electrical arc occurs the detector observes this and sends a signal to the motor control. This signal is in turn sent to the motor causing it to turn. This turning action causes the treaded male rod to turn and it moves toward the water. As it moves downward it in turn lowers the silver electrode down until it comes close enough to the water that the arcing stops. When the arcing stops then the signal to the motor stops and the motor stops turning.

### CROSS-REFERENCE TO RELATED APPLICATIONS.

This application relates to U.S. Pat. No. 6,214,299, APPARATUS AND METHOD FOR PRODUCING ANTIMICROBIAL SILVER SOLUTION.

### STATEMENT REGARDING FEDERALLY SPONSORED RESEARCH OR DEVELOPMENT.

Not Applicable.

### BACKGROUND OF THE INVENTION

1. The Field of the Invention

The present invention relates to the positioning of the silver electrode near the surface of the water automatically rather than by hand.

2. Description of Related Art

In the invention referenced above the silver electrode must be positioned very near the surface of the water to prevent it from drawing an electric arc. If an arc is generated the quality of the silver in solution is greatly diminished. It requires constant attention by the operator, manually turning a plastic extension on the male threaded member to keep it positioned just right in the solution With the many hundreds of male threaded members in the production it becomes a very labor intensive operation.

### BRIEF SUMMARY AND OBJECT OF THE INVENTION

This invention will automatically position the silver wire at the precise position above the water so that arcing will not occur. No operator is required to be in attendance.

### BRIEF DESCRIPTION OF THE DRAWINGS.

The above and other objects, features and advantages of the invention will become apparent from a consideration of the subsequent detailed description presented in connection with the accompanying drawings in which:

FIG. 1 is a perspective, schematic view of an apparatus for positioning the silver electrode at or near the surface of the water.

FIG. 2 is a detailed description of the connecting apparatus.

### DETAILED DESCRIPTION OF THE INVENTION

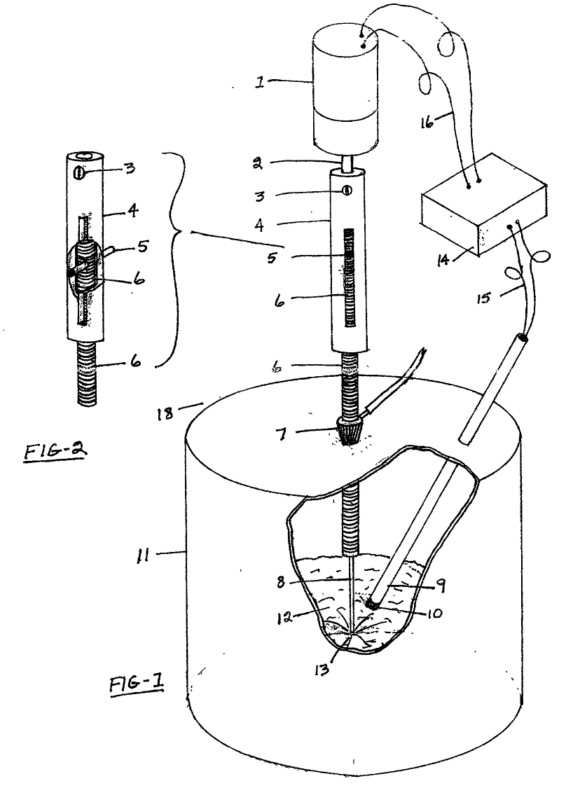

Referring now to FIGS. 1-2 there is shown an apparatus for producing a silver-based solution, the apparatus being designated generally at 18. This drawing is for but one electrode out of many in the surface of the process tank 11.

When the silver electrode (8) attached to the end of the treaded rod (6) comes near the water (12) in the process tank (11) and electric arc occures at (13). The light or electromagnetic radiation from this arc is detected by (10). This is held in place by a hollow plastic rod (9). A signal travels through the wires (15) from this detector (10) to the motor control (14) which in turn sends a signal to the gear motor (1). As this motor turns it turns the plastic, slotted, hollow shaft (4). Power is transferred from this hollow shaft to the treaded rod (6) via the pin (5). As this threaded rod (6) turns it travels up or down because of the holding action of the treaded nut (7). This then lowers or raises the silver electrode from the surface of the water depending on the direction of the motor rotation. When the electrode is in the proper position, arcing stops and the motor stops turning.

What is claimed is:

1. An apparatus for determining if an electric arc is occurring and repositioning the silver electrode so that the arcing stops, said apparatus comprising: at least one silver electrode made of silver element holding means for holding the end of the silver electrode, within 0.5 inch of the free upper surface of the fluid, power means for conveying electrical power to this electrode from a transformer.

2. The apparatus of claim 1:
The apparatus of claim 1, wherein the electrode holding member comprises an electrically conductive, male threaded cylindrical member, and wherein the positioning means comprises an electrically conductive female-threaded member fixedly secured to the lid within the hole formed in the lid and wherein the male-threaded cylindrical member is threadably engaged within the female-threaded cylindrical member in the first rotational direction operates to move said male-threaded cylindrical member downwardly, and rotating the male threaded cylindrical member in a second, opposing rotation direction operates to move said male-threaded cylindrical member upwardly.

3. The apparatus in claim 1, for transferring the rotational power from the gear motor to the male threaded cylindrical member with out conducting electricity from this male-threaded member to the motor.

4. The apparatus in claim 3, consisting of a plastic, cylindrical, hollow, slotted rod which fits over the male-threaded member.

5. The apparatus in claim 4, consists of a pin which goes through the male-threaded member and fits into the slots on the plastic, cylindrical, hollow, slotted rod. This locks the male-threaded threaded member to the plastic, cylindrical, hollow, slotted rod so that they turn together.

6. The apparatus in claim 1, wherein the motor turns, it in turn causes the plastic, cylindrical, hollow, slotted rod to turn. The pin transfers power to the male-threaded member causing it to turn.

7. The apparatus in claim 6, whereas the male-threaded member turns, it lowers itself down and in turn lowers the silver electrode toward the solution.

8. The apparatus in claim 7, consists of the silver electrode.

9. The apparatus in claim 8, comes near the solution then an electric arc occurres.

10. The apparatus in claim 9, wherein the detector observes this arc and sends a signal to the motor control.
